(19) United States
(12) Patent Application Publication
(10) Pub. No.: US 2026/0077679 A1
(43) Pub. Date: Mar. 19, 2026

(54) SYSTEMS AND METHODS FOR BATTERY FAULT DETECTION

(71) Applicant: Textron Inc., Providence, RI (US)

(72) Inventors: Gregory August Theodosakis, Martinez, GA (US); Russell William King, Evans, GA (US); Charles Daniel Dauchess, North Augusta, SC (US)

(73) Assignee: Textron Inc., Providence, RI (US)

(21) Appl. No.: 18/884,363

(22) Filed: Sep. 13, 2024

(51) Int. Cl. B60L 58/15; B60L 50/64; B60L 58/18

(52) U.S. Cl. CPC B60L 58/15; B60L 50/64; B60L 58/18; B60L 2200/22; B60L 2240/547; B60L 2240/549; B60L 2260/50

(57) ABSTRACT

A golf vehicle system includes a chassis, a front axle coupled to the chassis, a rear axle coupled to the chassis, a battery pack supported by the chassis and including a plurality of battery cells, and a vehicle control system. The vehicle control system is configured to monitor voltages of the plurality of battery cells, detect a voltage imbalance among the plurality of battery cells based on the voltages of the plurality of battery cells, and initiate a mitigating action in response to detecting the voltage imbalance.

### BACKGROUND

Electric vehicles typically include battery management systems. Battery management systems can monitor, control, and maintain the health and efficiency of batteries of such electric vehicles.

### SUMMARY

One embodiment relates to a golf vehicle system. The golf vehicle system includes a chassis, a front axle coupled to the chassis, a rear axle coupled to the chassis, a battery pack supported by the chassis and including a plurality of battery cells, and a vehicle control system. The vehicle control system is configured to monitor voltages of the plurality of battery cells, detect a voltage imbalance among the plurality of battery cells based on the voltages of the plurality of battery cells, and initiate a mitigating action in response to detecting the voltage imbalance.

Another embodiment relates to a vehicle system. The vehicle system includes a battery pack including a plurality of cells and one or more processing circuits. The one or more processing circuits are configured to monitor voltages of the plurality of battery cells, monitor currents of the plurality of battery cells, detect an imbalance among the plurality of battery cells based on at least one of the voltages or the currents of the plurality of battery cells, and initiate a mitigating action in response to detecting the imbalance.

Still another embodiment relates to a vehicle system. The vehicle system includes a battery pack including a plurality of cells and one or more processing circuits. The one or more processing circuits are configured to monitor voltages of the plurality of battery cells and to detect an imbalance among the plurality of battery cells based on the voltages of the plurality of battery cells. The one or more processing circuits are configured to detect the voltage imbalance among the plurality of battery cells in response to at least one of observing (a) an increasing voltage trend and a decreasing voltage trend within the battery pack simultaneously, or (b) determining that a maximum voltage imbalance between a lowest cell voltage and a highest cell voltage in the battery pack is greater than a threshold.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a site monitoring and control system including a plurality of the vehicles of FIG. 1, according to an exemplary embodiment.

FIG. 5 is a schematic block diagram illustrating the voltage behavior of individual battery cells within a battery pack of the vehicle of FIG. 3, according to an exemplary embodiment.

FIG. 6 is a block diagram of method for a battery fault detection protocol, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

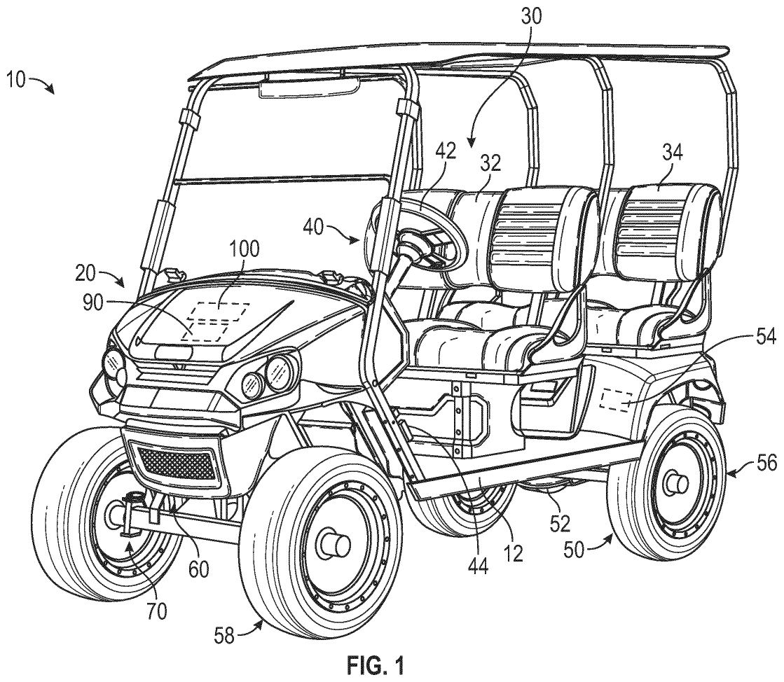

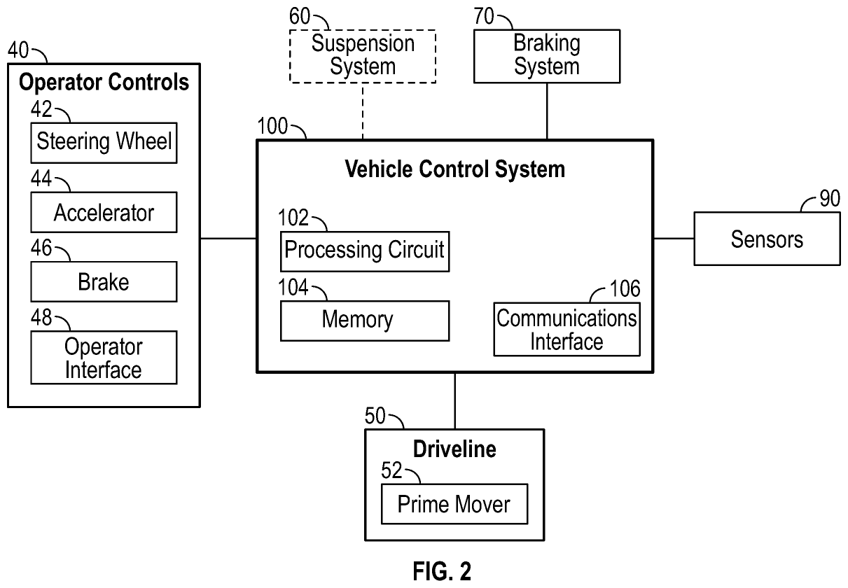

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., motor 53) and the energy storage 54 is a battery system (e.g., battery module 57, add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

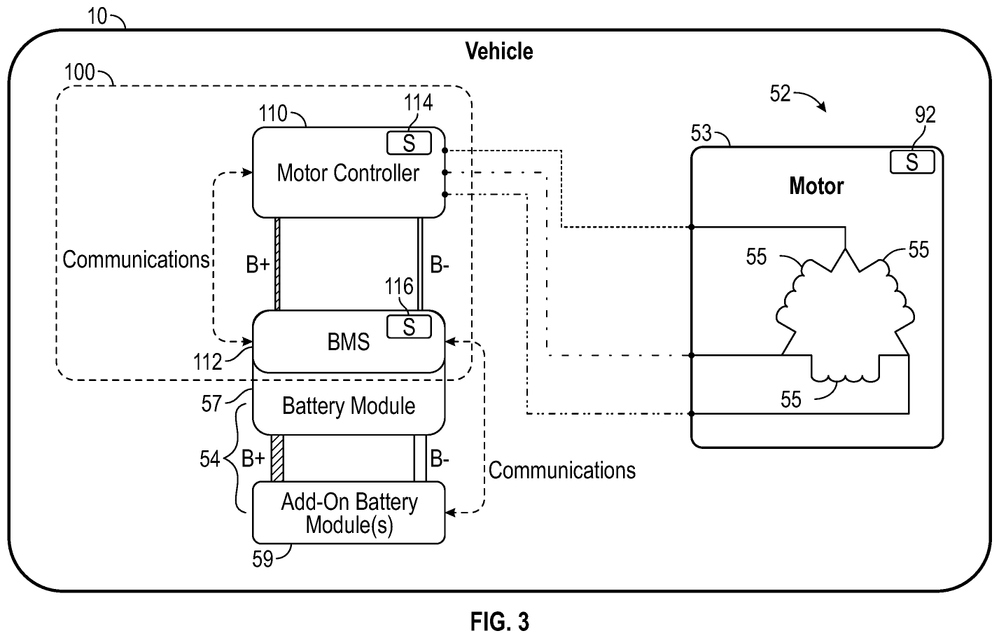

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows/groups of battery cells. The BMS 112 may be configured to monitor characteristics of the rows/groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, row/group, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein.

### Site Monitoring and Control System

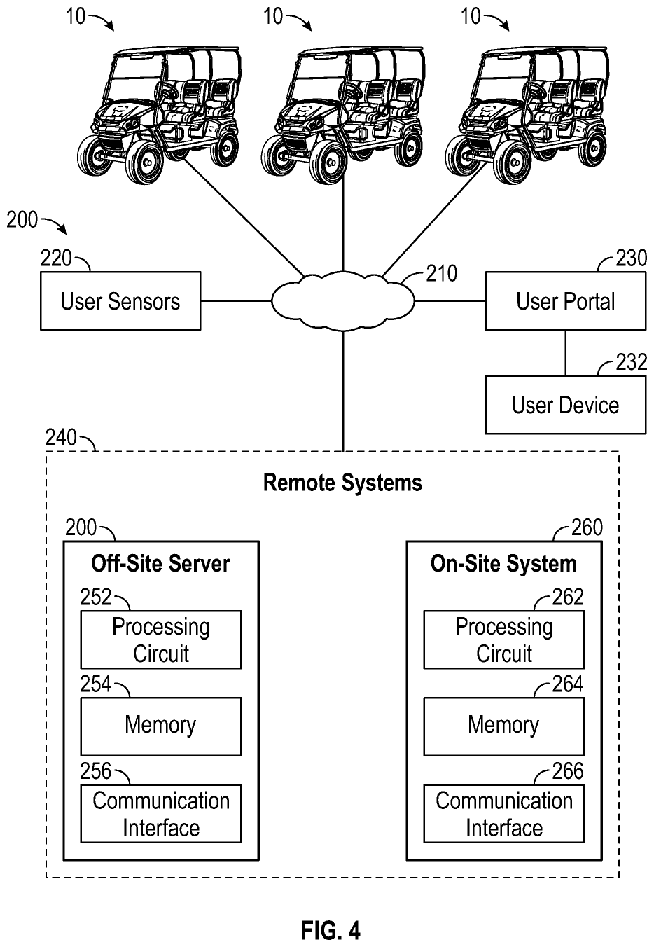

As shown in FIG. 4, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10 and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the site monitoring and control system 200 does not include the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Detecting Battery Imbalance

When a battery module within a battery system experiences a fault or failure condition, an imbalance may arise with the battery system. The faulty or failing battery module can be affected by other healthy battery modules within the battery system. For example, the voltage of a faulty or failing battery cells and/or battery modules may fall. As a result, a healthy battery module may attempt to maintain a constant voltage across the battery system by providing electric current to the faulty or failing battery modules, which can lead to an overcharge condition. In some cases, voltage imbalance can occur when individual cells within a battery module experience issues. If one or more cells within a battery module fail or degrade, their voltage can deviate from the rest, leading to an imbalance within the battery module. Accordingly, the systems and methods of the present disclosure, and as described in greater detail herein, are configured to detect imbalance conditions and take mitigating actions to prevent the healthy cells from reaching a critical voltage threshold and prevent or mitigate the overcharging condition.

According to an exemplary embodiment, the vehicle control system 100 is configured to monitor voltages of a plurality of battery cells within the energy storage 54 (e.g., the battery system, the battery module 57, the add-on battery module(s) 59, etc.). The vehicle control system 100, via the BMS 112, is programmed and/or configured to continuously or periodically measure the voltage levels of each battery cell within the energy storage 54. The BMS 112 may include a plurality of voltage sensors (e.g., sensors 116) positioned within the energy storage 54. Each voltage sensor may be directly coupled to an individual battery cell or to a subset of battery cells, allowing for precise monitoring of the voltage levels at a granular level. In one embodiment, the voltage sensors are integrated into a printed circuit board (“PCB”) that is mounted on or near the battery module 57. The PCB may be connected to each battery cell via conductive traces or wires, facilitating real-time or near-real-time voltage readings. The data collected by the voltage sensors may then be transmitted to the BMS 112, where the data can be processed and analyzed.

In accordance with one or more exemplary embodiments, the vehicle control system 100 includes an on-board processing circuit (e.g., the processing circuit 102, the BMS 112, etc.) located on the vehicle 10, which is responsible for real-time monitoring, control, and management of the systems of the vehicle 10, including the battery pack. The on-board processing circuit allows the vehicle 10 to respond immediately to any detected issues or changes in operating conditions. The vehicle control system 100 may include a second processing circuit located remote from the vehicle 10 (e.g., the remote systems 240). The remote processing circuit enables external monitoring, diagnostics, and system updates, providing the ability to analyze data and manage the performance of the vehicle 10 from a distance. The combination of both on-vehicle and remote processing circuits ensures comprehensive control and flexibility in maintaining and optimizing the vehicle 10 operations.

According to an exemplary embodiment, the BMS 112 is configured to monitor the voltage levels in multiple modes. In a continuous monitoring mode, the BMS 112 may receive constant and/or continuous readings from the BMS sensors 116, providing an ongoing stream of data regarding the health and status of each battery cell and/or module. The continuous monitoring mode can be used in applications where the energy storage 54 (e.g., battery system) is subject to rapid changes in load or environmental conditions. In a periodic monitoring mode, the BMS 112 may be programmed to measure or analyze the voltage levels at regular intervals, (e.g., every few seconds or minutes) or under specific conditions (e.g., during charging, discharging, or when the vehicle 10 is idle). The periodic monitoring mode can reduce the processing and power demands on the BMS 112. The periodic monitoring mode may be used when in applications where the energy storage 54 (e.g., battery system, etc.) is subject to low risk of sudden voltage imbalances.

In some implementations, the vehicle control system 100 (e.g., via the BMS 112) is configured to monitor the voltage levels via current sensors (e.g., by employing Ohm's Law, which relates voltage, current, and resistance (V=IR)). The vehicle control system 100 may detect a voltage imbalance among the plurality of battery cells based on voltage data and/or current data, allowing for flexibility in the monitoring approach depending on the specific conditions or operational requirements. In some configurations, the vehicle control system 100 is configured to determine the imbalance based on a combined analysis of both the voltages and the currents of the plurality of battery cells and/or battery modules. Detecting current flow between battery modules allows the vehicle control system 100 to identify when one battery module is charging (e.g., inadvertently charging) another battery module, which can signal a fault condition, even when voltage measurements and/or data appear normal or nominal. The current-based fault detection provides an additional layer of monitoring to detect imbalances that may not be apparent through voltage measurements alone.

According to an exemplary embodiment, the vehicle control system 100 is configured to stop monitoring the voltages and/or the currents of the plurality of battery cells and/or battery modules after a predetermined dwell time has elapsed. The dwell time may set based on specific operational conditions, such as the completion of a charging or discharging cycle, or when the vehicle 10 enters a low-power state. By ceasing the monitoring process after the dwell time, the vehicle control system 100 may conserve energy and reduce wear on the BMS sensors 116 and the BMS 112, particularly during periods when active monitoring is unnecessary. The dwell time may be a specific time period during which the vehicle control system 100 continues to monitor the battery cells and/or the battery modules after an event, such as the completion of a charging cycle. For example, the vehicle control system 100 may maintain monitoring for an additional ten minutes after charging of the energy storage 54 to ensure that any residual voltage fluctuations are detected before transitioning to a low-power state.

In some implementations, the vehicle control system 100 is configured to cease monitoring the voltage levels of the plurality of battery cells when specific parameters indicate that the risk of overcharge or thermal events is low. The vehicle control system 100 (via the BMS 112) may set predetermined thresholds for a highest cell voltage, a state of charge of the battery pack, and/or an overall battery pack voltage. When the highest cell voltage, the state of charge of the battery pack, and/or the overall battery pack voltage fall below the predetermined thresholds, the vehicle control system 100 determines that the battery pack contains minimal energy and thus presents a reduced risk for serious overcharge or thermal runaway events. The vehicle control system 100 may, therefore, conserve resources by limiting unnecessary monitoring when the likelihood of operational failure conditions are less severe.

The BMS 112 may be configured to enter a complete shutoff state under specific conditions, such as when the vehicle 10 is not in use for extended periods or during a deep sleep mode to conserve energy. During the complete shutoff state, the vehicle control system 100 may be configured to periodically re-activate the BMS 112, causing the BMS 112 to re-enter a monitoring state. During periodic activations, the BMS 112 may monitor the voltages and currents of the plurality of battery cells and/or battery modules to detect any imbalances or anomalies that may have developed during the shutoff period. This may ensure that the battery system remains ready for use, even during extended periods of inactivity.

The data collected by the BMS 112 regarding the battery system may be stored in the memory 104 for real-time analysis and future reference. The data may be utilized by the BMS 112 to calculate average voltage and/or current levels, track trends over time, and/or identify any deviations from expected performance. By comparing the data (e.g., voltage readings) against predefined thresholds or historical data, the BMS 112 can determine if any particular battery cell or module is showing signs of wear, imbalance, or other anomalies. The vehicle control system 100 may leverage this analysis to detect imbalances among the plurality of battery cells and/or modules. For example, the BMS 112 may be configured to identify when one or more cells exhibit a voltage level that deviates significantly from the acceptable range, indicating potential issues such as overcharging, undercharging, or a defective cell.

In some embodiments, detecting a voltage imbalance among the plurality of battery cells and/or modules includes recording the voltages over time and analyzing the rate of change in voltage. The BMS 112 may observe a voltage rise or fall per unit time that exceeds a threshold (e.g., a predefined threshold), which may indicate potential issues such as cell degradation or impending failure. The predefined threshold can also be referred to as voltage rate of change threshold. For example, if the voltage of a particular cell rises or falls more rapidly than expected and exceeds a threshold (e.g., a voltage increase of 0.2 volts per minute during a charging cycle), the BMS 112 may be configured to detect and/or flag this as an indication of a potential overcharging condition or cell degradation. A sudden drop in voltage at a rate exceeding the threshold during discharge could signal a failing cell that may no longer be able to maintain its charge. The voltage rate of change threshold during charging, discharging, and non-charging conditions can be the same or different.

In some embodiments, detecting the voltage imbalance among the plurality of battery cells additionally or alternatively includes comparing current voltages of the plurality of battery cells and/or modules to previous voltages recorded at an earlier time. The BMS 112 may determine an instantaneous difference between the current voltages and the previous voltages, identifying deviations that may indicate potential issues such as cell degradation or impending failure. This method allows for real-time detection of abnormal voltage fluctuations. The BMS 112 may achieve this by storing historical voltage data for each battery cell in the memory 104 and performing regular comparisons between the stored voltage data and the current voltage readings. The vehicle control system 100 may utilize differential analysis algorithms, such as a moving average differential or a rolling comparison algorithm, to calculate the instantaneous difference between the previous and current voltage levels for each cell and/or module. These algorithms can take the current voltage reading and subtract the corresponding historical voltage reading, which may be taken from a fixed time interval earlier (e.g., the last minute or hour), to determine the rate of change. If the resulting difference exceeds the predefined voltage rate of change threshold, the vehicle control system 100 may be configured to trigger appropriate responses, such as issuing an alert or adjusting the charging process for the affected cell.

The vehicle control system 100 may be configured to detect voltage imbalances among the plurality of battery cells by employing a statistical analysis method, such as regression analysis or standard deviation calculations, to identify abnormal voltage deviations. The vehicle control system 100 may analyze historical voltage data trends for each cell or module, establishing a baseline of expected voltage behavior over time. By comparing current voltage readings to these statistical models, the vehicle control system 100 may be configured to detect when a cell voltage deviates significantly from the predicted range, indicating a potential imbalance or malfunction. This approach allows the energy storage 54 to account for natural variations among its battery cells while accurately identifying cells that may require intervention.

To address the detected voltage imbalance, the BMS 112 may be configured to initiate corrective measures, such as adjusting the charge distribution among the cells or isolating the affected cell(s) to prevent further imbalance. The corrective measure may prevent critical voltage thresholds from being reached and mitigate the risk of overcharging or other hazardous conditions. The ability to detect and address voltage imbalances ensures that the battery system operates reliably, extending the lifespan of the battery cells and maintaining optimal performance across the vehicle 10.

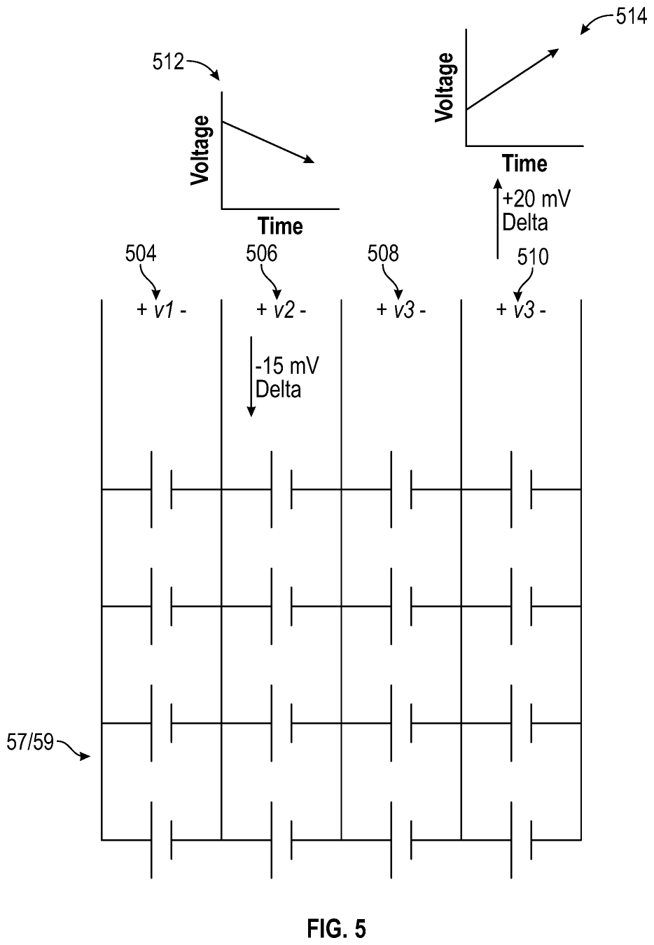

As shown in FIG. 5, the battery module 57 and/or the add-on battery module(s) 59 include a plurality of groups of battery cells including a first plurality of battery cells, shown as first group of battery cells 504, a second plurality of battery cells, shown as second group of battery cells 506, a third plurality of battery cells, shown as third group of battery cells 508, a fourth plurality of battery cells, shown as fourth group of battery cells 510, etc. The vehicle control system 100 is configured to monitor the voltage of each individual cell or group of cells 504-510 of the battery module 57 and/or the battery module(s) 59 over time. The BMS sensor 116 of the BMS 112 coupled to each of the groups of battery cells 504-510 enables real-time or periodic measurement of the voltage levels. For example, voltage v1 represents the voltage of the battery cells of the first group of cells 504, which are connected in parallel. Similarly, voltage v2, voltage v3, and voltage v4 each represent the voltages of their respective groups of battery cells 506-510, also connected in parallel. The groups of battery cells 504-510 are connected in series with each other within the battery module 57 and/or the add-on battery module(s) 59. This allows the BMS 112 to track the voltage trends for each cell or group of cells and identify any deviations that may indicate an imbalance within the battery module 57 and/or the add-on battery module(s) 59.

In some embodiments, the vehicle control system 100 (e.g., the BMS 112) is configured to detect a difference in voltage trends (e.g., one cell's or group's voltage increasing while another's is decreasing) that indicates an imbalance. The vehicle control system 100 is configured to detect the imbalance among the plurality of battery cells in response to observing an increasing voltage trend and a decreasing voltage trend within the battery pack simultaneously. For example, as shown in FIG. 5, when the voltage v2 decreases by −15 mV as indicated by voltage trend 512, while simultaneously or in a short period of time (e.g. 1 minute, 5 minutes, etc.) the voltage v3 increases by +20 mV as indicated by second voltage trend 514, the vehicle control system 100 can identify and flag a voltage imbalance. This simultaneous occurrence of opposing voltage trends signals that the cells or groups are not operating uniformly, which can indicate issues such as cell degradation or an emerging fault within the battery module 57 and/or the add-on battery module(s) 59. The vehicle control system 100 may then be configured to respond to these detected imbalances to maintain the health and performance of the battery system (e.g., issue a fault, take a mitigating action, etc.).

In some embodiments, the vehicle control system 100 (e.g., the BMS 112) is configured to detect the imbalance among the plurality of battery cells by calculating or determining the maximum voltage imbalance within the battery module 57 and/or the add-on battery module(s) 59. The maximum voltage imbalance may be determined by identifying the difference between a lowest cell voltage and a highest cell voltage in the battery module 57 and/or the add-on battery module(s) 59 at a given moment (e.g., if voltage v2 decreases by −15 mV while voltage v3 increases by +20 mV, the vehicle control system 100 would calculate/identify a maximum voltage imbalance of 35 mV). By comparing the maximum voltage imbalance to a maximum difference threshold, the vehicle control system 100 can assess whether the detected imbalance exceeds acceptable limits. For example, if the difference between the highest and lowest cell voltages surpasses the threshold, this may indicate that the cells are not charging or discharging uniformly, potentially leading to issues such as overcharging, undercharging, or cell degradation.

In some embodiments, the maximum difference threshold and/or the voltage rate of change threshold are predefined. In some embodiments, the vehicle control system 100 is configured to dynamically determine the maximum difference threshold and/or the voltage rate of change threshold based on current operational parameters of the vehicle 10. By way of example, the vehicle control system 100 may be configured to dynamically determine the maximum difference threshold and/or the voltage rate of change threshold using a mathematical function that takes into account various factors such as the SOC, temperature, time range, historical performance data (e.g., data collected by the BMS 112 and stored in memory 104) of the battery cells, as well as other factors including whether the vehicle 10 charging, is in use/driving, is stationary, is asleep, in a certain mode of operation, etc. The vehicle control system 100 can adjust the threshold(s) in real-time, ensuring that it is neither too sensitive nor too lenient under current operating conditions. For example, the threshold(s) may be set higher or more lenient during periods of rapid discharge and/or charging to account for expected voltage fluctuations, while the threshold(s) may be set lower or more strict during steady-state conditions to detect minor imbalances.

In some embodiments, in response to detecting the imbalance among the plurality of battery cells, the vehicle control system 100 is configured to initiate a mitigating action. The mitigating action may include transmitting a notification to a user (e.g., on the operator interface 48, on the user portal 230, on the user device 232, etc.). The notification may inform the user of the detected imbalance. In some embodiments, the notification advises the user to perform a specific action, such as reducing the load on the vehicle 10, initiating a controlled charging cycle, unplugging the vehicle 10 from a charger, disconnecting the battery module 57 and/or the add-on battery module(s) 59, scheduling maintenance, and/or still other manually implementable mitigating actions. The notification can be transmitted through a vehicle display system, mobile app, or directly to a vehicle dashboard warning lights. The notification can be triggered immediately upon detecting the imbalance, especially if the vehicle control system 100 determines that the issue may affect the vehicle performance. For example, a message might appear on the dashboard display indicating that an imbalance has been detected and advising the user to reduce the vehicle's load or avoid high-rate charging until the issue is resolved. The notification can also be sent to the user's mobile app, providing details about the imbalance and suggesting actions, such as scheduling a maintenance check. This real-time communication ensures that the user is promptly informed and can take appropriate action to mitigate the detected issue.

According to an exemplary embodiment, the mitigating action(s) can include automated responses. The vehicle control system 100 can set a fault, triggering an alert or warning that can be logged for diagnostic purposes. In some cases, where the detected imbalance poses a significant risk to the functionality of the battery pack, the vehicle control system 100 may disable the battery pack entirely or perform a controlled discharge procedure to prevent potential damage or hazardous conditions. Such disabling actions may, therefore, prevent operating the vehicle 10 with a compromised battery. Further details regarding possible mitigating actions may be found in U.S. patent application Ser. No. 18/797,207, filed Aug. 7, 2024, which is incorporated herein by reference in its entirety.

In some embodiments, the vehicle control system 100 is be configured to prevent the initiation of mitigating actions during periods of high-rate discharge or high-rate charge. During periods of high-rate discharge or high-rate charge, the battery cells may experience rapid and significant changes in voltage, which could be transient and not necessarily indicative of a persistent imbalance. By delaying the mitigating actions until the high-rate discharge or charge period has stabilized, the vehicle control system 100 avoids unnecessary interventions that could disrupt the operation of the vehicle 10 or reduce the battery's operation and efficiency. Such a procedure therefore may ensure that the vehicle control system 100 only responds to genuine imbalances.

### Monitoring and Managing Battery Cell Imbalances

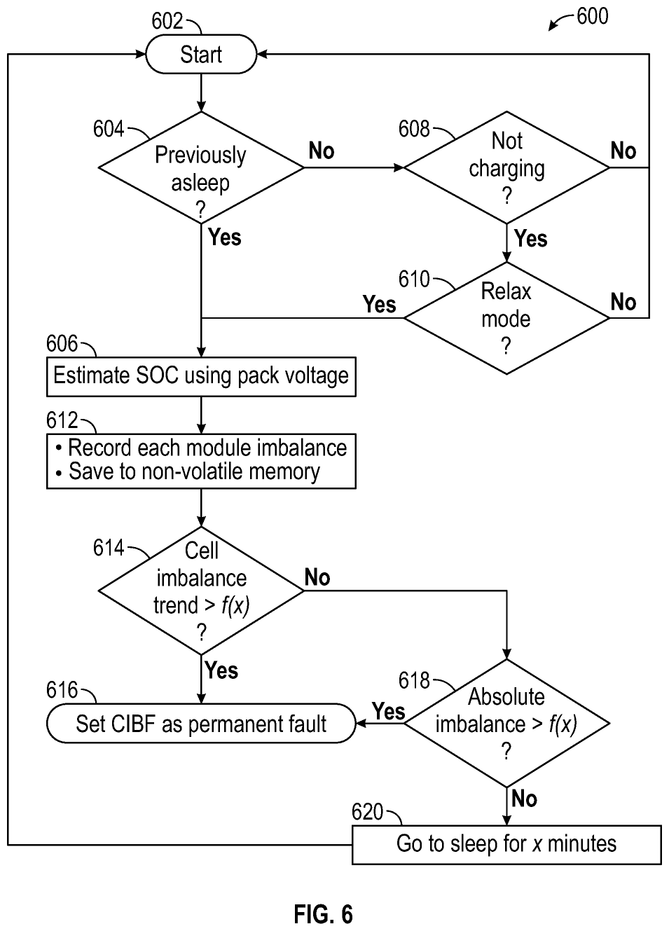

As shown in FIG. 6, a method 600 for monitoring and managing battery cell imbalances and faults is depicted. Method 600 may be performed by the vehicle control system 100 (e.g., the BMS 112, the motor controller 110, etc.). The method 600 may be implemented using any one or more of the components and devices detailed herein in conjunction with FIGS. 1-5. Additional, fewer, or different operations may be performed in the method 600 depending on the embodiment. At least one aspect of the operations is directed to a system, method, apparatus, or a computer-readable medium.

At step 602, a vehicle control system (e.g., the vehicle control system 100, the BMS 112, etc.) is configured to monitor a battery system (e.g., the energy storage 54, the battery module 57, the add-on battery module(s) 59, etc.) of a vehicle (e.g., the vehicle 10). At step 604, the vehicle control system is configured to determine whether the battery system was previously in a sleep mode (asleep). If the battery system was previously asleep, at step 606, the SOC of the battery system is estimated via sensors (e.g., the BMS sensors 116) using the pack voltage. If the battery system was not asleep, at step 608, the vehicle control system is configured to check whether the battery system is not charging. If the battery system is not charging, at step 610, the vehicle control system is configured to determine whether the vehicle is in a relax mode (e.g., low-activity state, a sleep state, battery is neither charging nor discharging at a significant rate). When the vehicle is in relax mode, then at step 606, the SOC of the battery system is estimated. If the vehicle is not in relax mode or is charging, the vehicle control system is configured to return to step 602 and to monitor the battery system.

After estimating the SOC of the battery system, at step 612, the vehicle control system is configured to record the imbalance (e.g., voltage, current, etc.) of each module of the battery system and save this data to non-volatile memory (e.g., the memory 104) to ensure that historical data is retained for future analysis and trend monitoring. Each module's imbalance may be or include the voltage differences between a highest voltage (of a cell or group of cells) in the module and a lowest voltage in the module. At step 614, the vehicle control system is configured to determine whether a cell imbalance trend exceeds a predefined function, f(x). If the imbalance trend is greater than the function f(x), at step 616, the vehicle control system is configured to set a cell imbalance fault (“CIBF”) as a permanent fault, indicating a significant and persistent imbalance that requires attention. The function f(x) can be a fixed threshold value that remains constant regardless of other conditions (e.g., if the voltage imbalance exceeds a constant threshold of 50 mV, the vehicle control system triggers a fault). The function f(x) can be based on the state of the battery system, such as the SOC, temperature, battery age, and/or current operation of the vehicle. For instance, the threshold might be lower at higher SOC levels, where the battery is more sensitive to imbalances, or adjusted based on the operating temperature of the battery cells. The function f(x) may include a time-dependent function. The time-dependent function may include a time factor, where the threshold adjusts based on the duration of the detected imbalance. For example, a small imbalance that persists over a longer period might trigger the system, whereas a larger imbalance might be acceptable for short periods. In some implementations, the function f(x) may be a dynamic or adaptive threshold function and can change in real-time based on ongoing monitoring data. For example, the vehicle control system may calculate a moving average of the voltage imbalance and set f(x) as a threshold based on deviations from this average.

If the cell imbalance trend does not exceed the function f(x), at step 618, the vehicle control system is configured to assess whether the absolute imbalance within the battery system exceeds function f(x). The absolute imbalance within the battery system can consider the entire battery system, which is composed of multiple modules. The absolute imbalance can measure the maximum voltage difference across all the cells in the entire pack, regardless of which module the cells belong to. If the absolute imbalance exceeds the threshold, at step 616, the vehicle control system is configured to set the CIBF as a permanent fault, indicating a significant and persistent imbalance that requires attention.

If the absolute imbalance does not exceed the threshold, at step 620, the vehicle control system is configured to enter a sleep mode for a specified period (e.g., 1, 5, 10, etc. minutes). The sleep mode allows the system to conserve energy while still maintaining periodic checks on the battery system.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and descriptions may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle system comprising:
a golf vehicle including:
a chassis;
a front axle coupled to the chassis;
a rear axle coupled to the chassis; and
a battery pack supported by the chassis, the battery pack including a plurality of battery cells; and
a vehicle control system configured to:
monitor voltages of the plurality of battery cells;
detect a voltage imbalance among the plurality of battery cells based on the voltages of the plurality of battery cells; and
initiate a mitigating action in response to detecting the voltage imbalance.

2. The golf vehicle system of claim 1, wherein the vehicle control system is configured to stop monitoring the voltages after a dwell time.

3. The golf vehicle system of claim 1, wherein the vehicle control system includes a battery management system coupled to the battery pack, wherein the battery management system is configured to enter a complete shutoff state, and wherein the vehicle control system is configured to cause the battery management system to periodically re-enter a monitoring state during the complete shutoff state to monitor the voltages.

4. The golf vehicle system of claim 1, wherein the vehicle control system is configured to detect the voltage imbalance among the plurality of battery cells in response to observing an increasing voltage trend and a decreasing voltage trend within the battery pack simultaneously.

5. The golf vehicle system of claim 4, wherein detecting the voltage imbalance among the plurality of battery cells includes recording the voltages over time and observing a voltage rise or fall per unit time that exceeds a threshold.

6. The golf vehicle system of claim 4, wherein detecting the voltage imbalance among the plurality of battery cells includes comparing current voltages of the plurality of battery cells to previous voltages of the plurality of battery cells and determining an instantaneous difference between the current voltages and the previous voltages.

7. The golf vehicle system of claim 1, wherein the vehicle control system is configured to detect the voltage imbalance among the plurality of battery cells utilizing a statistical analysis method to determine abnormal voltage deviations based on historical voltage data trends.

8. The golf vehicle system of claim 1, wherein the vehicle control system is configured to detect the voltage imbalance among the plurality of battery cells by:
calculating a maximum voltage imbalance in the battery pack where the maximum voltage imbalance is a difference between a lowest cell voltage and a highest cell voltage in the battery pack;
comparing the maximum voltage imbalance to a threshold; and
dynamically determining the threshold based according to a mathematical function.

9. The golf vehicle system of claim 8, wherein the vehicle control system is configured to determine the threshold according to the mathematical function using at least two of a state of charge of the battery pack, time, or the maximum cell voltage.

10. The golf vehicle system of claim 1, wherein the vehicle control system is configured to:
monitor a maximum cell voltage and a state of charge of each of the plurality of battery packs; and
cease monitoring the voltages of the plurality of battery cells when at least one of the maximum cell voltage, the state of charge, or a pack voltage falls below a predetermined threshold.

11. The golf vehicle system of claim 1, wherein the vehicle control system is configured to prevent the mitigating action during periods of high-rate discharge and high-rate charge.

12. The golf vehicle system of claim 1, wherein the mitigating action includes transmitting a notification for a user to perform a certain mitigating action.

13. The golf vehicle system of claim 1, wherein the mitigating action includes setting a fault.

14. The golf vehicle system of claim 13, wherein the mitigating action includes disabling the battery pack if necessary.

15. The golf vehicle system of claim 1, wherein the vehicle control system is configured to:
analyze the voltages over time;
predict a potential failure condition based on the voltages over time; and
initiate a preemptive mitigating action before an actual failure condition.

16. The golf vehicle system of claim 1, wherein the vehicle control system includes at least one of (a) a first processing circuit located on the golf vehicle or (b) a second processing circuit located remote from the golf vehicle.

17. The golf vehicle system of claim 1, wherein the vehicle control system is configured to:
determine if the battery pack was previously in sleep mode;
determine if the battery pack is not charging;
determine if the battery pack is in relax mode;
estimate a state of charge (SOC) of the battery pack using the battery pack voltage;
save recorded module imbalances to non-volatile memory;
compare cell imbalance trends to a predefined function;
set a permanent fault condition if a cell imbalance trend exceeds the predefined function; and
enter sleep mode for a specified time-period if an absolute imbalance does not exceed the predefined function.

18. The golf vehicle system of claim 1, wherein the vehicle control system is configured to:
monitor currents of the plurality of battery cells;
detect a current imbalance among the plurality of battery cells based on the currents of the plurality of battery cells; and
initiate the mitigating action in response to detecting the voltage imbalance or the current imbalance,
wherein the voltage imbalance is determined based on both the voltages and the currents of the plurality of battery cells.

19. A vehicle system comprising:
a battery pack including a plurality of battery cells; and
a one or more processing circuits configured to:
monitor voltages of the plurality of battery cells;
monitor currents of the plurality of battery cells;
detect an imbalance among the plurality of battery cells based on at least one of the voltages or the currents of the plurality of battery cells; and
initiate a mitigating action in response to detecting the imbalance.

20. A vehicle system comprising:
a battery pack including a plurality of battery cells; and
one or more processing circuits configured to:
monitor voltages of the plurality of battery cells; and
detect an imbalance among the plurality of battery cells based on the voltages of the plurality of battery cells; wherein the one or more processing circuits are configured to detect the voltage imbalance among the plurality of battery cells in response to at least one of:
(a) observing an increasing voltage trend and a decreasing voltage trend within the battery pack simultaneously; or
(b) determining that a maximum voltage imbalance between a lowest cell voltage and a highest cell voltage in the battery pack is greater than a threshold.
